(19) United States
(12) Patent Application Publication
(10) Pub. No.: US 2003/0222055 A1
(43) Pub. Date: Dec. 4, 2003

(54) Welding gun

(76) Inventors: Udo Marek, Euskirchen (DE); Karl Poll, Aachen (DE); Elmar Lange, Gummersbach (DE)

Correspondence Address: Patent Group, Choate, Hall & Stewart, Exchange Place, 53 State Street, Boston, MA, 02109-2804, US

(21) Appl. No.: 10/308,934

(22) Filed: Dec. 3, 2002

(30) Foreign Application Priority Data
May 28, 2002 (DE) 102 23 821.9

(51) Int. Cl. B23K 11/11

(52) U.S. Cl. 219/86.25

(57) ABSTRACT

A welding gun has two projecting electrode arms that are interconnected and able to move relative to each other and whose free ends each hold one welding electrode. The welding gun also has an electrode drive that moves the electrode arms from a closed position, in which the welding electrodes are located close together, to an open position. The welding gun projecting electrode arms have a movement sequence that optimizes welding precision. The electrode arms are attached to a linear guide so that they are able to be displaced linearily relative to each other.

### BACKGROUND

1. Technical Field

The present invention relates to a welding gun, having two projecting electrode arms which are interconnected and able to move relative to each other and whose free ends each hold one welding electrode, and also having an electrode drive which moves the electrode arms from an open position to a closed position in which the welding electrodes are located close together.

2. Description of Related Art

Welding guns of two fundamentally different designs, which are used for resistance spot welding, in particular for welding sheet metal in the automotive industry, are known from publications describing the related art, in particular from German Patent Application 198 59 020 A1 and German Utility Patent 201 07 328 U1. The two designs are illustrated in FIGS. 1 through 3 of the attached drawing.

The first welding gun type is generally known as a ,,C-type” and is shown in FIG. 1. It includes a largely C-shaped electrode arm 1 of a largely rigid design. A first welding electrode 2 is provided at the free end of the C-shaped electrode arm.

An electrode drive 5 is attached to the other end of C-shaped electrode arm 1, a second electrode 3 being attached to its longitudinally movable drive shaft 4. Second electrode 3 is in alignment with first electrode 2. When both electrodes 2, 3 are in the closed position, drive shaft 4 of electrode drive 5 presses electrode 3 against electrode 2. At least two workpieces, usually made of sheet steel, are clamped between electrodes 2 and 3 during welding. A welding transformer 6 that generates a welding current is connected to electrodes 2, 3. The welding current flows through the workpieces clamped between both electrodes 2, 3. This heats the workpieces in the area between welding electrodes 2, 3 and forms a welding spot. The alignment of the electrodes with each other and the specific electrode force with which the electrodes are pressed against the workpiece are determining factors in the quality of the welding spot produced.

Because welding electrodes 2, 3 execute a relative movement at the beginning of and during welding, an additional equalizer drive 60 is provided, enabling C-shaped electrode arm 1 and electrode drive 5 to move linearly relative to a mounting plate 8 for mounting on a robot arm. A linear ball bearing 7 guides C-shaped electrode arm 1, which is mountable on a mounting case, relative to mounting plate 8.

A characteristic feature of such C-type guns is that the drive shaft is arranged as an extension of the electrode axis, and the travel movement of electrode 3 is exclusively linear. In contrast to the X-type welding guns described below, they have only one electrode arm 1, which is in the shape of a C and is usually attached to the mounting case of the welding gun. Second electrode 3 is mounted as an extension of electrode drive 5. The advantage of this arrangement is that C-type welding guns weigh less than welding guns having a second electrode arm. The purely linear movement of electrode 3 has also proven to be advantageous for welding. However, the special geometry of the C-type welding gun greatly limits its field of application, since electrode drive 5 provided as an extension of electrode 3 requires free accessibility to the workpiece to be welded.

A further welding gun type, namely the ,,X-type”, has therefore become popular. Two different embodiments of this welding gun type are shown in FIGS. 2 and 3.

An X-type welding gun has two projecting electrode arms, one welding electrode being attached to each of its free ends. An electrode holder, on which the welding electrode itself is mounted, is provided at each free end of the electrode arms. The two electrode arms (9 and 10 in FIG. 2 and 9′ and 10′ in FIG. 3) are pivotably connected on an articulated shaft 11. Electrode drive 17, 17′ swivels one of electrode arms 10, 10′ relative to other electrode arm 9, 9′. An equalizer drive 12 is again provided which is connected to a mounting plate 13 as well as to one of electrode arms 9, 9′. The closed position of both electrodes 15, 16 is located on welding plane 14, which may be varied by adjusting equalizer drive 12.

X-type welding guns have the advantage over C-type welding guns that, using an appropriate design of electrode arms 9, 10; 9′, 10′, spot welds may be applied even in poorly accessible areas. Extensively projecting electrode arms are possible in the case of these welding gun types, giving them a great reach.

However, a number of disadvantages arise when swiveling electrode arms 9, 10 or 9′, 10′, which are pivoted like the pivot joint of a pair of scissors. The free ends of the electrode arms move along a circular path around the pivot joint. Electrode holders 18, 19 are attached to the free ends of the electrode arms and extend largely tangentially with respect to said circular path of said free ends. The electrodes 15, 16 are mounted on said electrode holders 18, 19. An ideal welding plane 14 (see FIGS. 2 and 3) extends through the articulated shaft 11. In the closed position of the welding gun both electrodes 15, 16 contact said ideal welding plane 14 and both electrode holders 18, 19 are in alignment with each other. The insertion of the workpieces to be welded requires electrodes 15, 16 to execute a certain opening movement away from welding plane 14. This positions electrodes 15, 16 and electrode holders 18,19 at an angle relative to each other. The contact angle of electrodes 15, 16 changes. If electrodes 15, 16 are no longer positioned adjacent the ideal welding plane, for example due to the use of unsuitable electrode holder dimensions, not only do the electrodes come into contact at an oblique angle, but the electrode axes are displaced. On the whole, the oblique and displaced electrode contact has a negative effect on the welding result, i.e., on the quality of the welding spot produced.

In addition, both electrode drive 17, 17′ and electrode drive 5′ of the C-type gun from FIG. 1 apply a pressure to close the welding electrodes. It is important to prevent the drive shaft of the electrode drive from buckling and being damaged when the welding gun closes. For this reason, the drive shaft must have an adequately stable design and move without any lateral excursion, so that relatively high forces may be applied to close the welding gun with the necessary electrode force.

The X-type gun in FIGS. 2 and 3 has the further disadvantage that the force of electrode drive 17, 17′ is transmitted by a lever formed by driven electrode arm 10, 10′. If it is necessary to use a long electrode arm 10, 10′, the electrode force varies according to the lever ratio. The combined requirement of high electrode forces and long electrode arm working radii means that very high driving forces are needed.

Additional disadvantages of the known X-type gun having two projecting electrode arms are as follows:

It takes up a lot of space, and the welding gun is very heavy;

There is usually a large distance between the center of gravity of the welding gun and the mounting plate;

Because the welding gun must be designed for a certain electrode arm/electrode holder combination due to the required arrangement with respect to the pivot point, changing the electrode holder lengths alone has a negative impact on welding suitability;

The X-type guns known up to now are complicated and comparatively expensive to produce and assemble.

### SUMMARY OF THE INVENTION

The present invention provides a simple welding gun having projecting electrode arms and optimized movement sequences (kinematics).

In one embodiment of the present invention, this is achieved by use of a linear guide to which the electrode arms are attached so that they move linearly and transversely to each other.

In other words, the electrode arms are mounted on a guide device, preferably a linear guide with roller bearings or a linear friction bearing, which holds the arms in a manner such that they are linearly displaceable relative to each other in the transverse direction. The linear guide preferably extends at largely right angles to the longitudinal direction of the electrode arms and largely parallel to the longitudinal axis of the electrode holders.

Based on one design according to the present invention, the electrode drive moves the electrode arms, to which the electrode holders are attached, and ultimately the electrodes themselves, in an exclusively linear manner even as the welding gun closes. This prevents drifting or excursion of the welding electrodes in any direction during the closing movement or changes in the contact angle of the welding electrodes. Regardless of the workpiece thickness or position in the displacement path of the electrodes during closing motion, each welding electrode comes into contact with the workpiece being welded at a predetermined location and predetermined angle. The welding electrodes are thus in alignment. The spot weld to be created by resistance welding is therefore always produced under the same conditions.

As explained below, both the linear guide of the electrode arms and the electrode drive are implementable in a space-saving and economical manner by using standardized components. The welding gun occupies less mounting space and is more economical to produce.

According to an advantageous embodiment of the present invention, the linear guide has a (stiff) non-bending design. As mentioned above, a roller bearing may be used as the linear guide. For example, it is possible to use a linear guide that includes a guide rail having guide grooves for bearing balls and a guide carriage. The guide carriage has a bead chain, allowing it to move linearly on the guide rail with little friction. One electrode arm is connected to the guide rail. The second electrode arm is connected to the guide carriage.

According to an advantageous embodiment of the present invention, the moved electrode arm is connected by the linear guide to a base of the gun. A suitable arrangement is achieved in the event that the guide rail is connected to the moved electrode arm using suitable fasteners and possibly additional reinforcement. Depending on the requirements, one or more guide carriages are mounted in the welding gun base. The second electrode arm is connected to the base either directly or via suitable fastener.

According to a further embodiment, one electrode arm is attached to the guide rail and the second electrode arm to one or more guide carriages. Also in this case, a base may be provided to reinforce the unit.

According to another embodiment of the present invention, the electrode drive is arranged in a way that generates a tensile force to move the electrode arms into the closed position. Thus, the electrode drive is provided between the electrode arms in a manner such that it pulls the electrode arms toward each other, thereby transmitting the closing force to the welding electrodes. To apply the necessary closing force, only a tensile stress is applied to the electrode drive to minimize the buckling forces that may cause lateral excursion of the drive rod. The drive rod itself may have a less rigid design. Since the electrode drive may have a more compact design, it possible to reduce costs and weight compared to conventional welding guns, in particular welding guns having projecting electrode arms.

It is further advantageous that the electrode drive transmits a constant closing force to the electrodes independent of the length of the electrode arms. Because the electrode arms are guided linearly, no lever action occurs while the welding gun is closing.

A welding gun according to the present invention can be produced with a very uniform weight distribution and a very low overall weight, using a small number of industrially manufactured components. It is therefore advantageously usable on robot arms, which expose the welding gun to high acceleration rates. It is also economical to manufacture.

To achieve a larger opening of the welding gun, it is possible to deviate from the linear movement after a translatory opening movement of a certain amount has been performed. The linear closing movement, which takes place largely in the longitudinal direction of the electrode holder, is necessary only near the closed position of the welding gun. The electrodes need to be aligned with each other only as the electrodes are being closed for producing the spot weld. The kinematics of electrode movement are less critical at greater distances from the closed position.

For this reason, one embodiment of the welding gun having linearly displaceable electrode arms has a pivot joint that amplifies the opening movement. This pivot joint is active only when the electrodes are located at a distance from their closed position. Swiveling at least one of the electrode arms makes it possible to substantially amplify the opening movement of the electrodes relative to each other even with a small drive stroke.

The pivot joint is provided on a divided base member between the two electrode arms. The electrode drive preferably engages with the electrode arms in the area between the pivot joint and the free ends of the electrode arms. The electrode drive may be provided as close as possible to the pivot joint. During linear movement of the electrodes for closing the welding gun, the electrode drive force is transmitted to the electrodes in a 1:1 transmission ratio. The closing movement occurs at the speed of the electrode drive itself. When the welding gun opens, the electrode arms first pass through the area of the linear guidance and are then swiveled away from each other. Because the electrode drive is provided as close as possible to the pivot joint, its lever is very small in relation to the lever of the free ends of the electrode arms. The relatively slow movement of the electrode drive with a high force causes the free ends of the electrode arms to move very fast with a low force during the swiveling movement.

The combined linear and swivel drive thus causes the electrodes to close linearly in a comparatively slow and controlled manner applying a predefined high force and causes the welding gun to open in a fast and low-force swiveling movement allowing even large parts to be moved between the electrodes of the welding gun. The low force during swiveling is sufficient because no contact pressure needs to be generated at a distance from the closed position. This fast opening and closing of the welding gun shortens the amount of time needed to open the welding gun after producing a spot weld and positioning the welding gun to produce the next spot weld. When manufacturing a car body that has a large number of spot welds, this may considerably shorten the production time.

As mentioned above, the movement of the electrode arms should be positively driven and guided so that they are movable toward each other exclusively in a linear manner near the closed position. The swivel movement, which causes the welding gun to open quickly, takes place in a second movement segment.

The linear closing movement may take place, for example, over a distance of at least 5 mm. The distance of the linear movement should be greater than the sum of the maximum thickness of the workpieces to be welded, the flexure of the electrode arms by the set electrode force and the permissible electrode wear.

According to one embodiment of the present invention, the electrode arms are connected to the linear guide so that they are movable in the direction of their longitudinal axes. This makes it possible to vary the longitudinal section of the electrode arms that is projecting over the linear guide. Different welding gun geometries are achievable using one pair of electrode arms. The electrode arms should be lockable in their displacement positions by at least one locking mechanism. To adjust the welding gun geometry, the electrode arms need only be displaced in the longitudinal direction and locked in the predefined displacement position. This does not change the mechanical properties of the welding gun, in particular the electrode force or closing angle of the electrodes.

The welding gun may also be provided with longitudinal adjusting drives that move the electrode arms in the longitudinal direction. In this manner, different welding gun geometries are settable, if necessary, for different welding spots during automatic operation of the welding gun on a robot or during manual handling.

In a similar way, the electrode holders may also be adjustably attached to the free ends of the electrode arms. Once again, the electrode holders are lockable in different adjustment positions by fastening devices. Changing the length of the electrode holders has no affect on the electrode angle or electrode excursion, since, close to the closed position, the electrodes execute only a linear motion in the direction of the electrode holder. It is again possible to use a driving mechanism, namely an electrode holder drive that automatically moves the electrode holder in the longitudinal direction. An electrode holder drive of this type also makes it possible to vary the length of the electrode holder during welding gun operation.

For use on a robot arm, a welding gun according to the present invention should have an equalizer drive known from the related art, enabling the welding plane to be adjusted. According to one embodiment of the present invention, an equalizer drive is provided which shifts the closing position of the welding gun. This equalizer drive, in turn, is able to transmit the equalizer movement to the welding gun as a linear movement. To do this, the welding gun has a mounting plate that may be used to attach it to a robot arm. The base of the gun having the directly connected electrode arm is preferably connected to the mounting plate, for example by a linear roller bearing or friction bearing, so that it is linearly movable. Like the opening and closing drive of the welding gun, the equalizer drive also executes a linear movement of the components connected via the equalizer drive, in particular the electrode arms, parallel to the longitudinal extent of the electrode holders.

Alternatively, a welding gun according to the present invention may be used as a hand-operated gun without any major structural changes. For positioning on the workpieces, the welding gun weight is balanced by a balancer, and the welding gun is placed in any position manually by a worker. The welding gun is connected to the manually movable holding shackle of the balancer via a pivot bearing, which is attached to the welding gun base instead of the robot mounting plate, equalizer drive and corresponding guide.

According to one embodiment of the present invention, the electrode arms are made of light alloy profiles. The light alloy profiles may be extruded profiles. This makes it possible to produce the electrode arms in different lengths at very reasonable cost.

The extruded profiles preferably have grooves in which tubes are provided for conducting coolant. In other words, the electrode arms are designed as very economical, straight components. They are preferably made of simple, economical extruded aluminum profiles. The electrode arms are producible in any length by cutting the extruded profiles to the necessary size. The extruded profiles have grooves on their outer surfaces in which tubes, e.g., made of copper, may be provided to form cooling ducts. To ensure efficient heat transfer between the tubes and the extruded profiles, the tubes should be pressed into the ducts. This makes it possible to avoid expensive cutting or drilling operations or casting in producing electrode arms with cooling ducts.

The use of a linear bearing that defines the movement of the electrode arms as a purely linear movement during the working stroke provides numerous advantages. The electrode arms are moved at right angles to their longitudinal axes and largely parallel to the extension of the electrode holders at the free ends of the electrode arms. The electrodes come into accurate contact with the objects to be welded throughout the entire working stroke range of the electrode arms, for example 200 mm. The working stroke is not necessarily limited to 200 mm. However, a limitation of this type is useful to limit the length and weight of the linear bearing and the electrode drive.

Electrode opening movements that are larger than these dimensions are theoretically achievable by using longer linear guides. However, the linear guide is required only in the closing area of the welding gun. In the case of relatively small drive movements, it is possible to achieve a large electrode opening movement by providing a pivot joint of the electrode arms in addition to the linear guide. When the electrodes are in the closed position, the electrode drive first makes the electrode arms execute a linear movement in the direction of the longitudinal axes of the electrode holders, i.e., at right angles to the longitudinal direction of the electrode arms. A swivel movement around the pivot joint is then executed. The electrode drive should engage with the electrode arms near the pivot joint. This converts a small stroke of the electrode drive to a large swivel movement of the free ends of the electrode arms. The electrode drive is able to generate very large opening movements and strong closing forces of the welding gun using a very compact space. Locking the pivot joint near the welding gun closing point ensures that the electrodes move toward each other in a linear manner in the final portion of the working stroke. The locking action may be performed by crank guides that are provided by guide grooves on the side of the swiveling part of the welding gun in which guide pins or guide rollers are guided on the swiveling part. The welding gun movement is fixedly predefined in this manner. Alternatively, pegs on one part of the linear guide may engage with peg holes in another part of the linear guide in the end area of the closing movement, enabling both parts to execute a linear movement. Outside the engagement of the pegs, the swivel movement is enabled so that the swiveling movement is inevitably triggered by pushing the movable electrode arm against a stop of the linear guide.

According to one embodiment of the locking mechanism, the movement of the guide rail causes two pins to lock an upper and a lower part of the base of the welding gun together, thereby suppressing swivel movement. Conversely, the pins lock the linear movement of the electrode arm in the event that the swivel movement of both parts of the base of the gun relative to each other is enabled. In this case, the pins form a stop for the linear movement of the movable electrode arm, because they no longer engage with the locking holes when both parts of the base are swiveled with respect to each other.

It is also possible to provide different welding guns for different welding tasks. For example, one welding gun having a small opening stroke and no pivot joint may be provided for simple and uniform welding tasks. A refined embodiment has the pivot joint and a large opening stroke. The same components are largely usable for both welding guns because only the pivot joint and, if necessary, the positive guide for the swiveling electrode arm need to be retrofitted for the second welding gun.

Any driving means and motors may be used for the electrode drive, for example pneumatic or hydraulic driving cylinders or electric motors. The same applies to the equalizer drive used to move the linear guide of the welding gun for shifting the welding plane as well as to the longitudinal adjusting drive for adjusting the length of the electrode arms and the electrode holder drive for adjusting the length of the electrode holders, should drives of this type be provided on the welding gun.

The welding gun according to the present invention having linearly movable electrode arms has the following advantages over the known X-typeguns:

They are considerably lighter in weight.

Less space is required for the main welding gun elements (base, guides, drive, compensator).

It is less expensive to produce the electrode arms from standard sections or profiles.

The electrode force corresponds to the driving force, regardless of the length of the electrode arms.

When using a pivot joint, the welding gun may have an opening angle of nearly any size.

During swivel motion, the electrodes open at very high speeds.

The electrode arms are attachable to both parts of the linear guide moving relative to each other, using any electrode arm mounting device.

The linear roller bearing guide has almost no backlash.

Electrode excursion or drift during closing movement or when changing the welding plane as well as when changing the contact angle is largely eliminated due to the linear movement in the direction of the electrode holder.

The center of gravity is very close to the mounting plate used to attach the welding gun to a robot arm or a holding device.

Both the length of the electrode arms and the length of the electrode holders are infinitely variable without having a negative impact on welding quality caused by changes of the contact geometry or the closing force of the electrode.

The welding gun according to the present invention is suitable for holding any electrode arm pair.

All components, including the bearings, require very little maintenance and are quickly assembled.

The type of drive (hydraulic, pneumatic, electric) for the welding gun is freely selectable, depending on the equipment of the production site in which it is used.

The mechanical components of the welding gun and the welding transformer, which is usually situated close to the linear drive and feeds the welding current into the electrode arms, may be protected against spatter from the weld by a simple housing or a simple cover.

When using the welding gun as a hand-operated gun, inexpensive pivot bearings are usable for attaching the welding gun to a supporting arm. The welding gun is easy to use thanks to its light weight.

### BRIEF DESCRIPTION OF THE DRAWING

Embodiments of the present invention are explained in greater detail below on the basis of FIGS. 4 through 19 of the attached drawing, where:

FIG. 1 is a schematic showing a side view of an embodiment of a C-type welding gun according to the related art, as described above;

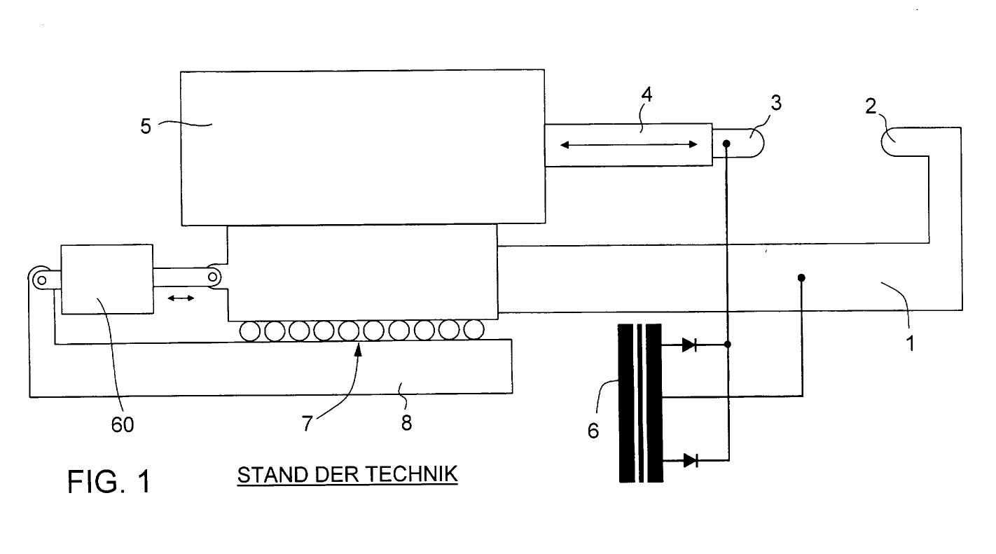

FIG. 2 is a schematic showing a side view of an embodiment of an X-type welding gun according to the related art, as described above;

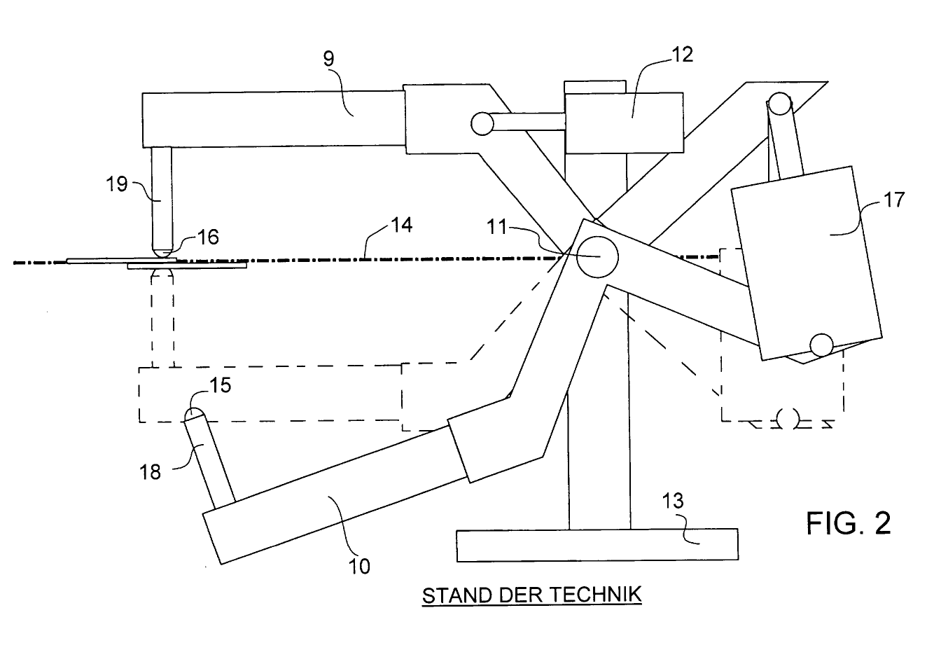

FIG. 3 is a schematic showing a side view of an alternative embodiment of an X-type welding gun according to the related art, as described above;

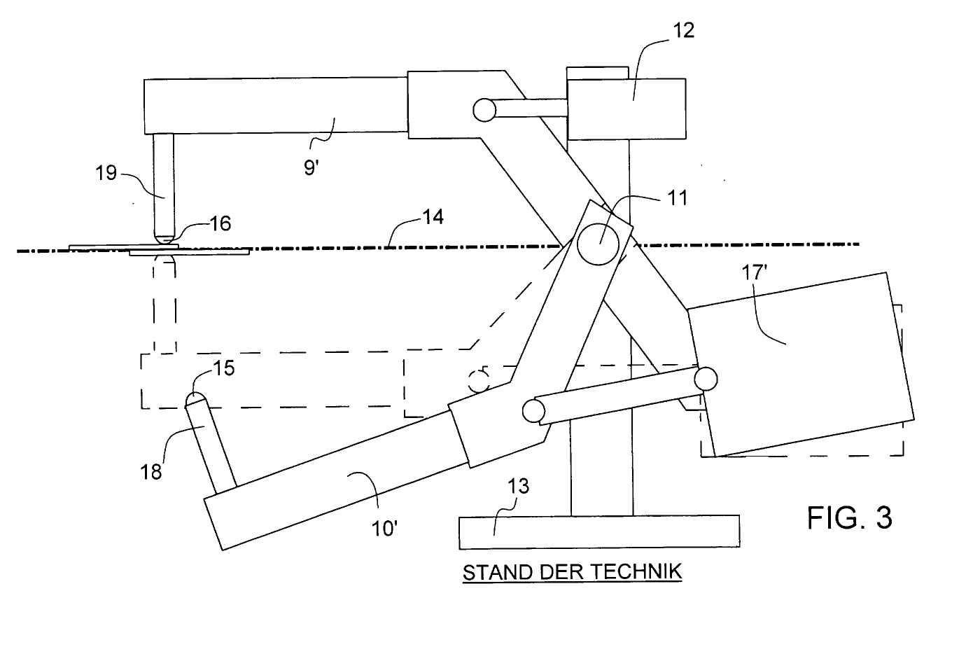

FIG. 4 is a schematic showing a side view of a first embodiment of a welding gun according to the present invention;

FIG. 5 is a schematic showing a side view of a second embodiment of a welding gun according to the present invention;

FIG. 6 is a schematic showing a side view of a third embodiment of a welding gun according to the present invention;

FIGS. 6a, 6b are schematics showing enlarged representations of details of the welding gun from FIG. 6;

FIGS. 7a,7b are schematics showing a front view and a side view of an embodiment of a locking mechanism for the welding gun according to the present invention in the position in which the swivel movement is blocked and linear movement enabled;

FIGS. 8a, 8b are schematics showing views of the locking mechanism according to FIGS. 7a and 7b in the position in which the swivel movement is enabled and the linear movement blocked;

FIG. 9 is a schematic showing a side view of a device for attaching the welding gun according to the present invention to a robot arm;

FIG. 10 is a schematic showing a side view of a device for attaching a welding gun according to the present invention to a holding shackle for manual operation;

FIG. 11 is a graphical representation of a roller bearing to be used as a linear guide of the welding gun according to the present invention;

FIGS. 12-15 are graphical representations of a further embodiment of the welding gun according to the present invention in four different opening positions.

### DESCRIPTION OF PREFERRED EMBODIMENTS

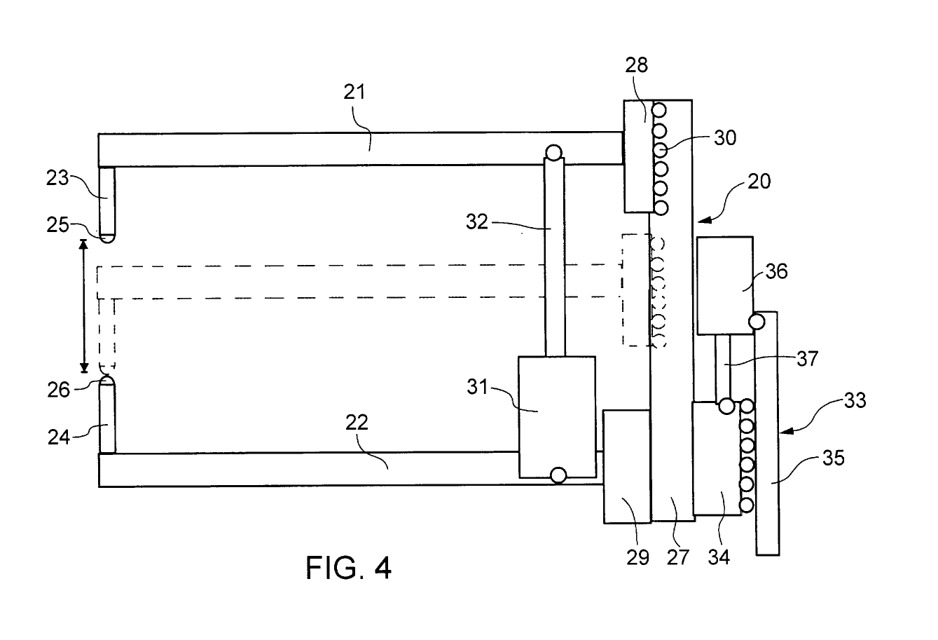

A welding gun according to the present invention and illustrated in FIG. 4 has two straight, parallel electrode arms 21, 22 that are mounted on a linear guide 20. Two electrode holders 23, 24, which hold welding electrodes 25, 26, are attached to the free ends of electrode arms 21, 22. Each electrode holder 23 and 24, respectively, extends from electrode arm 21 and 22, respectively, to which it is attached in the direction of opposite electrode arm 22 and 21, respectively. The center lines of electrode holders 23, 24 are in alignment and extend at largely right angles to the center line of electrode arms 21, 22. In the closed position of upper electrode arm 21, shown by the broken lines in FIG. 4, electrodes 25, 26 lie flush against each other or, during welding, against workpieces inserted between them.

Linear guide 20 includes a guide rail 27, positioned at a right angle to electrode arms 21, 22, and a guide carriage 28. Lower electrode arm 22 is more or less rigidly attached to guide rail 27 via a fastening element 29. Guide carriage 28 is held on guide rail 27 in a way that allows linear movement by rollers 30, preferably balls. Guide carriage 28 supports upper electrode arm 21.

Note that the linear guide may have a different design, for example, a sliding guide without rollers. Linear guide 20 has a certain rigidity to allow the necessary electrode forces to be transmitted to welding electrodes 25, 26 at the free ends of electrode arms 21, 22. The linear guide may also be reinforced by suitable components to increase its rigidity.

A electrode drive 31, which engages with both electrode arms 21, 22 near linear guide 20, is provided to open and close the welding gun. The points for attaching electrode drive 31 to electrode arms 21, 22 lie along a line parallel to guide rail 27.

Electrode drive 31 is preferably formed by an electric motor that moves a drive rod 32 in the axial direction via an integrated gear, for example a ball screw spindle or a roller screw spindle.

As shown in the drawing—unlike the related art—the closing force of the welding gun is produced by retracting drive rod 32. If a tensile force is acting upon drive rod 32, there is no danger of drive rod 32 buckling in the lateral direction. To transmit the same force, a drive rod under tensile load may therefore have a less rigid design than a drive rod under compression. Lateral guidance of drive rod 32 is not necessary in the case of a tensile load.

FIG. 4 shows that electrode holders 23, 24 are in alignment and the contact angle of the electrodes is constant over the entire displacement path of upper electrode arm 21. Thus, the same geometric conditions generally exist at the contact point between electrodes 25, 26 and the workpiece, regardless of the thickness of the workpieces clamped between electrodes 25, 26. The same is true when shifting the closing plane of the welding gun according to the present invention. Guide rail 27 of linear drive 20 is, in turn, attached to a guide carriage 34 of a second linear bearing 33. Guide rail 35 of this second linear bearing 33 forms a fastening element for attaching the welding gun to a robot arm. An equalizer drive 36 is attached to guide rail 35 and moves guide carriage 34. This enables guide rail 27 of linear guide 20 to be moved in its longitudinal direction, which shifts the closing plane of the welding gun defined by lower welding electrode 26.

Even if the closing plane is shifted by equalizer drive 36, the center lines of both electrode holders 23, 24 remain on a common straight line and are not swiveled as they are by the equalizer drive of an X-type gun. Equalizer drive 36 thus has no effect on the alignment and position of welding electrodes 25, 26 relative to each other. This prevents a negative impact on welding quality due to undesired changes in the positions of the electrodes relative to each other.

The linear movement in the transverse direction of electrode arms 21, 22 is necessary only for closing the welding gun. When the welding gun closes, the workpieces to be welded are clamped in place and the necessary electrode force is applied. This is done in an optimum manner only in the case of aligned electrode holders. This condition is guaranteed by the linear guide. The opening movement of the welding gun in the areas where welding electrodes 25, 26 are positioned some distance apart does not have to be linear.

FIG. 4 shows only schematic representations of the individual elements of the welding gun according to the present invention. According to a practical embodiment, a part 27 of the linear guide and electrode arm 22 fixedly connected thereto are combined to form a base of the welding gun in a common casing. Electrode drive 31 and a welding transformer are connectable to this base of the welding gun.

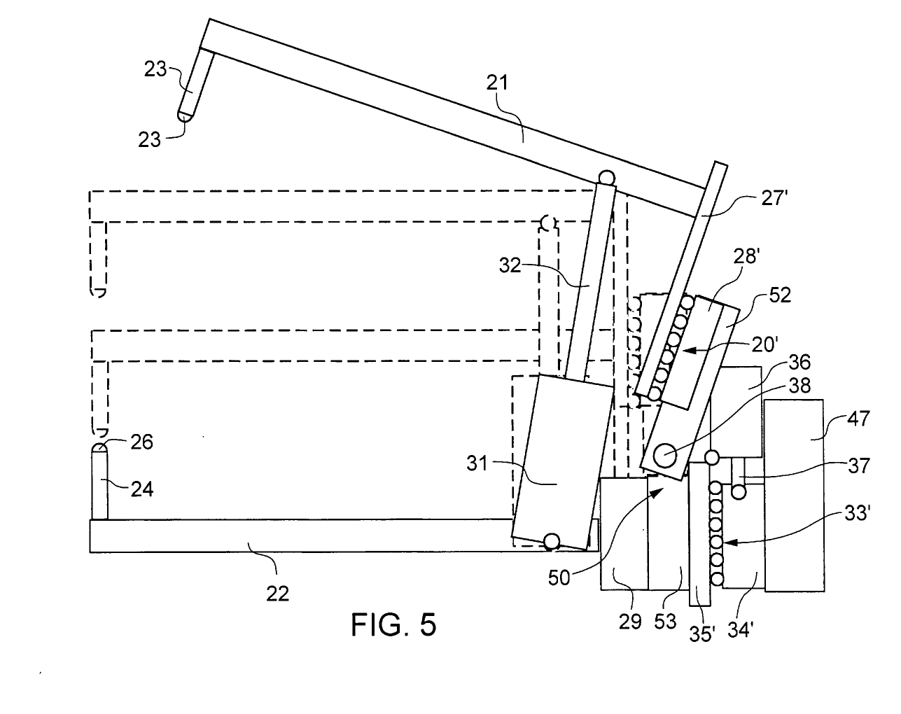

FIG. 5 shows an alternative embodiment of the welding gun according to the present invention, in which a pivot joint 38 is provided in addition to linear guide 20′ to amplify the opening movement of welding electrodes 25, 26.

According to this embodiment, guide rod 27′ is fixedly connected to moving electrode arm 21. Guide carriage 28 is a permanent component of a base 50 of the welding gun to which other electrode arm 22 is attached. Base 50 includes two sections 52, 53 that are interconnected via pivot joint 38. Electrode arm 22 is attached by fastening element 29 to lower section 53. Guide carriage 28′ of linear guide 20′, on which guide rail 27′, and thus electrode arm 21, is displaceably guided, is attached to upper section 52 of base 50.

Once again, the rigidity of guide rail 27′ may be increased by a reinforcing element to increase the electrode force. It is further possible to connect guide rail 27′ to swiveling part 52 of base 50 via multiple guide carriages 28′, thereby also increasing the rigidity.

The components of the embodiment shown in FIG. 5, which are identical to the components of the embodiment according to FIG. 4, are identified by the same reference numbers. In FIG. 5, the components of the welding gun are shown in the maximum open position. Broken lines illustrate an intermediate position and a closed position.

When the welding gun opens, moving electrode arm 21 first moves from the closed position to the intermediate position shown in FIG. 5. Guide rail 27′ moves in guide carriage 28′ fixed to base 50 until a stop limits the linear movement between guide carriage 28′ and guide rail 27′. A further opening stroke of electrode drive 31 swivels both sections 52, 53 of base 50 of welding gun relative to each other. This swivel movement places electrodes 25 and 26 far apart from each other.

According to the arrangement of electrode drive 31 near pivot joint 38 illustrated in FIG. 5, a small additional stroke of electrode drive 31 produces a very large swivel movement of the free end of upper electrode arm 21. The free end of electrode arm 21 moves at a very high speed during the swivel movement. Conversely, the force transmitted to the end of the electrode arm is weak during the swivel movement, due to the lever effect. However, this is not important in the opening movement of the welding gun. In the portion of movement in which the welding gun closes, moving electrode arm 21 is moved exclusively linearly in the direction of the electrode holder so that the force of the electrode drive is transmitted without losses to electrodes 25, 26.

In the case of the equalizer drive shown in FIG. 5, the elements of linear bearing 33′ are again inverted compared to those in FIG. 4. Guide rail 35′ of linear bearing 33′ is fixedly connected to lower section 53 of base 50. Guide carriage 34′, on the other hand, is connected to mounting plate 47 used to attach the welding gun to a robot arm.

Moving electrode arm 22 is preferably positively driven, which means that, when electrode arms 21, 22 reach a certain distance apart a control mechanism blocks further linear movement and enables the swivel movement. At this distance, pivot joint 38 is blocked when electrode arms 21, 22 are drawn together and the linear guide is enabled.

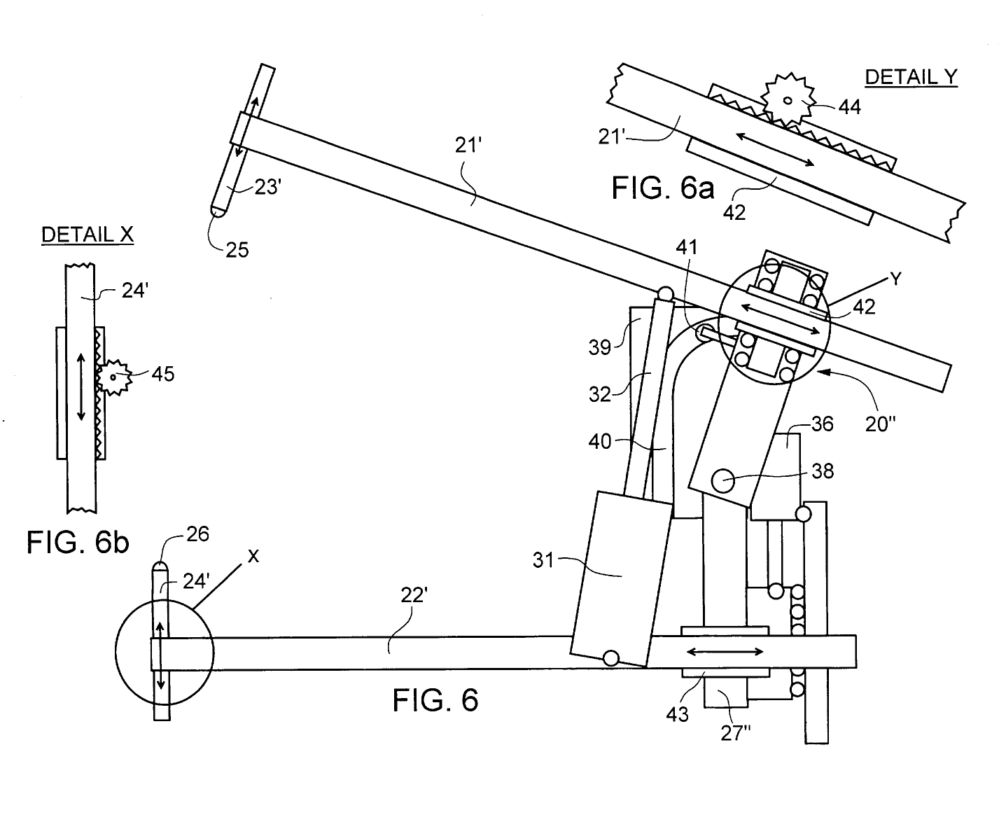

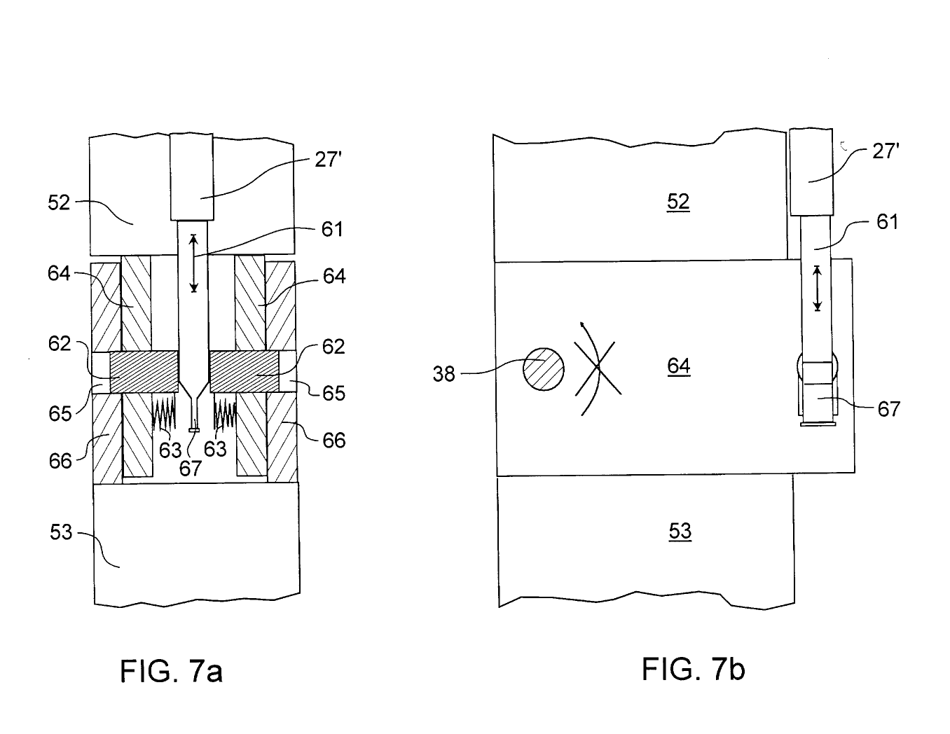

An embodiment of this type is illustrated in FIG. 6. In this case, a crank guide 39 having a guide groove 50 in which is guided a guide roller 41 that is rigidly connected to the moving part of linear guide 20, is provided in addition to linear guide 20,,. Crank guide 39 fixedly defines the path of the moving part of linear guide 20,, and thus that of moving electrode arm 21′. According to the illustration in FIG. 6, linear guide 20,, and guide rail 27,, differ from the embodiments described above.

In particular, a hollow attachment socket 42, through which passes upper movable electrode arm 21′, is provided on the movable part of linear guide 20,,. Lower electrode arm 22′ is also attached to the components of the welding gun base by a hollow attachment socket 43.

As shown in the detail illustrated in FIG. 6a, a longitudinal adjusting drive in the form of a pinion is provided in the area of attachment socket 42, enabling electrode arm 21′ to be moved into a certain position in the direction of its longitudinal axis and locked in place by stopping longitudinal adjusting drive 44. The same applies to lower electrode arm 22′. This makes it possible to adjust the length of the electrode arms to implement different welding gun geometries. It is, of course, also possible for electrode drive 31 to engage with attachment sockets 42, 43 instead of engaging with electrode arms 21′, 22′, as shown.

In the event that the electrode arms of the welding gun are positioned so that they are movable in their longitudinal direction, the axis of the pivot bearing is not provided at right angles to the extension of the electrode arms, but rather at an angle that deviates from 90 degrees so that the ends of the electrode arms do not collide in the case of large swivel angles. According to this embodiment, it is also advantageous to provide flexible leads at the ends of the electrode arms as power connections to the transformer.

According to the embodiment in FIG. 6, electrode holders 23′, 24′ are also displaceably attached to the free ends of electrode arms 21′, 22′. The detail illustrated in FIG. 6b shows that driving pinion 45 acts as an electrode holder drive. Electrode holders 23′, 24 are thus movable in the direction of their longitudinal axes.

Alternatively, both the electrode arms and the electrode holders are adjustable via a spindle system. In this case, the components to be moved have, for example, a driving spindle that moves back and forth through the rotation of a driving nut.

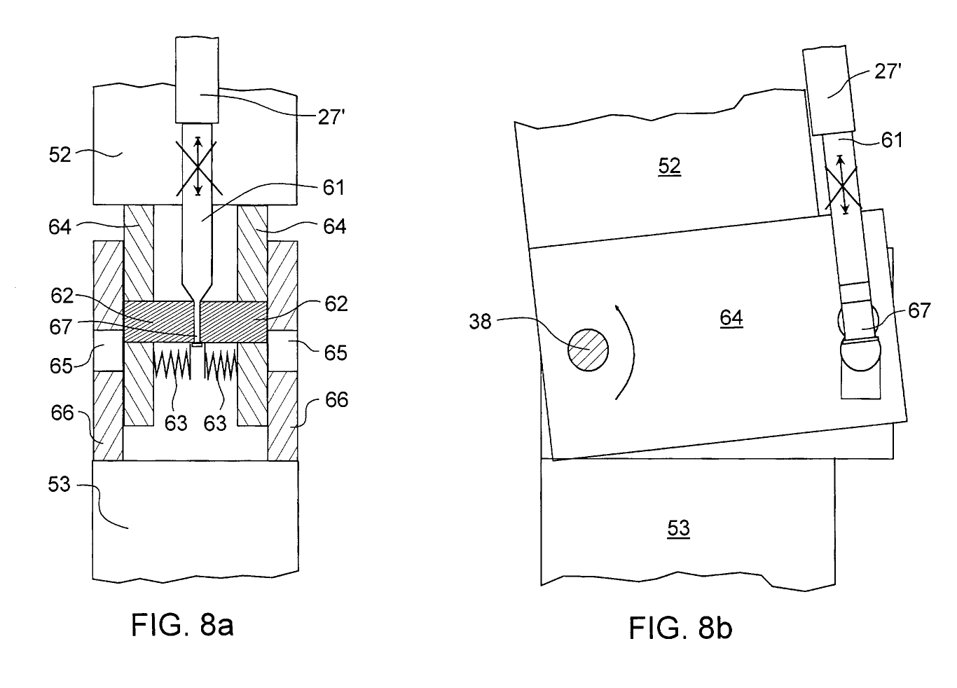

An alternative positive drive, which is advantageously usable in the welding gun embodiment shown in FIG. 5, is illustrated in FIGS. 7a and 7b as well as 8a and 8b. FIG. 7a shows a front view and FIG. 7b a side view of a control mechanism of this type in a first position. Guide rod 27′ is connected to a flat control bar 61 which moves between two control pins 62. Each control pin 62 is inserted into a hole in an inner control web 64 and is drawn out of this hole towards other control pin 62 against control bar 61. Both inner control webs 64 are connected to upper swiveling part 52 of base 50 (see FIG. 5).

In the position shown in FIGS. 7a and 7b, a wide section of control bar 61 presses both control pins 62 into holes 65 in outer control webs 66. Outer control webs 66 are connected to lower stationary part 53 of base 50 of the welding gun.

The insertion of control pins 62 in the holes in inner control webs 64 as well as in the holes in outer control web 66 blocks the swivel movement around pivot joint 38 and thus between both parts 52 and 53 of base 50. The linear movement of guide rail 27′, on the other hand, is enabled, since it is counteracted by only a weak friction between the adjacent surfaces of control pins 62 and guide rail 61.

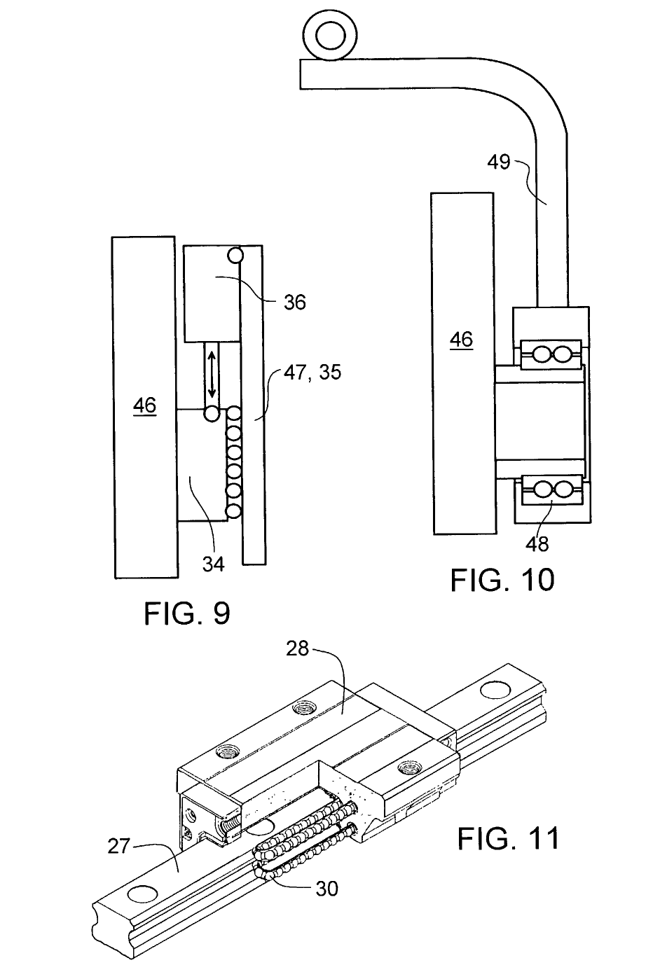

Once the linear displacement between electrode arms 21, 22 (see FIG. 5) has reached its maximum value, guide rail 27′, together with control bar 61, is in the position shown in FIGS. 8a and 8b. Here, control pins 62 lie against a narrow end section 67 of control bar 61 and are drawn completely out of holes 65 in outer control webs 66 by the force of springs 63. In this position, the swivel movement around pivot joint 38 is possible, allowing both parts 52, 53 of base 50 to swivel toward each other. A linear movement of guide rail 27′, on the other hand, is blocked. Because it is impossible to push control pins 62 to the outside, control bar 61, and thus guide rail 27′, are blocked in the maximum displacement position. Only after electrode drive 31 (FIG. 5) closes, causing parts 52, 53 of base 50 to move back into the position shown in FIGS. 7a and 7b, are control pins 62 able to be moved against the spring force into holes 65 in outer control webs 66. Then only a linear movement and no swiveling of both electrode arms 21, 22 (FIG. 5) relative to each other is again possible.

The different embodiments of a positive drive described with reference to FIGS. 6 and FIGS. 7a, 7b, 8a, 8b show that this positive drive is implementable in any number of ways.

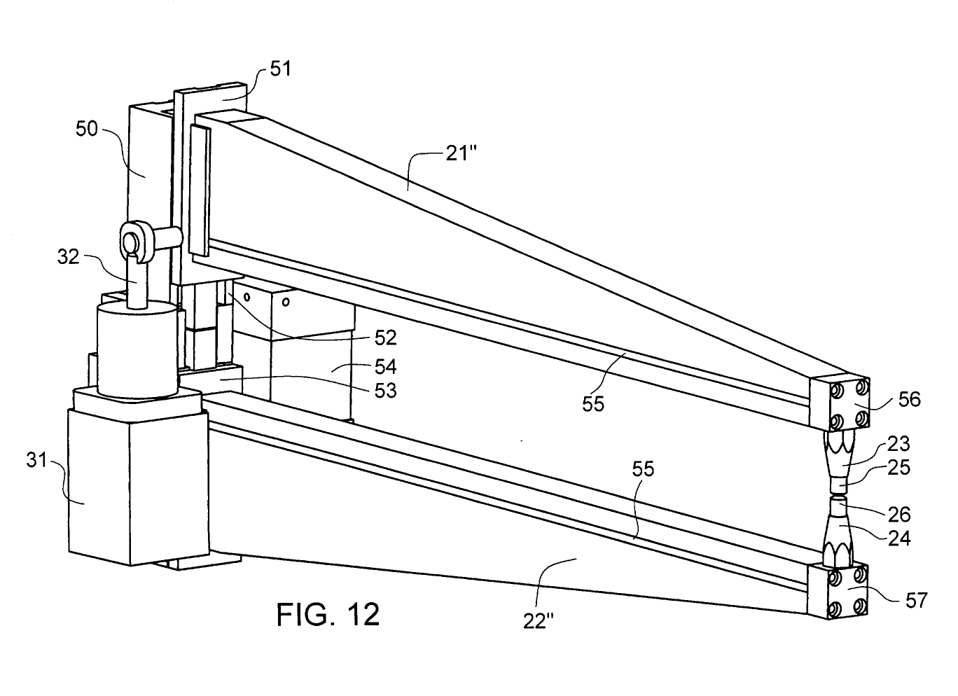

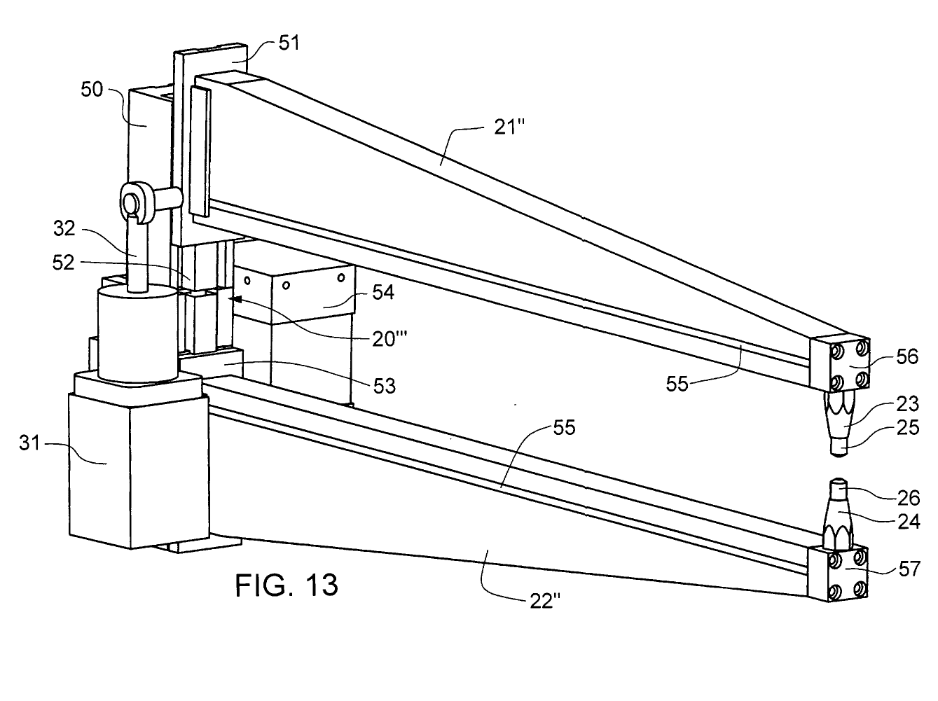

FIGS. 9 and 10 shows two different methods for attaching the welding gun. Reference number 46 identifies the welding gun base in general, which includes the linear drive and, if necessary, the swivel drive, to which the electrode arms are attached. According to FIG. 9, welding gun base 46 is attached to a flange plate 47, into which guide rail 35 of the linear bearing is integrated, via equalizer drive 36, which is known from the preceding FIG. 4 and has a linear bearing 33. Equalizer drive 36 may be used to adjust the plane in which the welding electrodes touch each other. Flange plate 47 is provided for the purpose of mounting the arrangement on a multi-axis robot arm for automatic movement to the various welding positions. The robot arm provides only rough alignment of the welding electrodes in conjunction with the transport devices for the workpieces to be welded. Equalizer drive 36 then fine tunes the welding plane in which the workpieces to be welded are located.

FIG. 10 shows an alternative embodiment in which welding gun base 46 is attached to a holding shackle 49 via a hollow pivot bearing 48. Holding shackle 49 is moved by servo drives, enabling welding gun base 46 to be placed into any welding position manually without exerting excessive force.

Because the welding gun according to the present invention is relatively light-weight, it is possible to use simple, inexpensive pivot bearings 48.

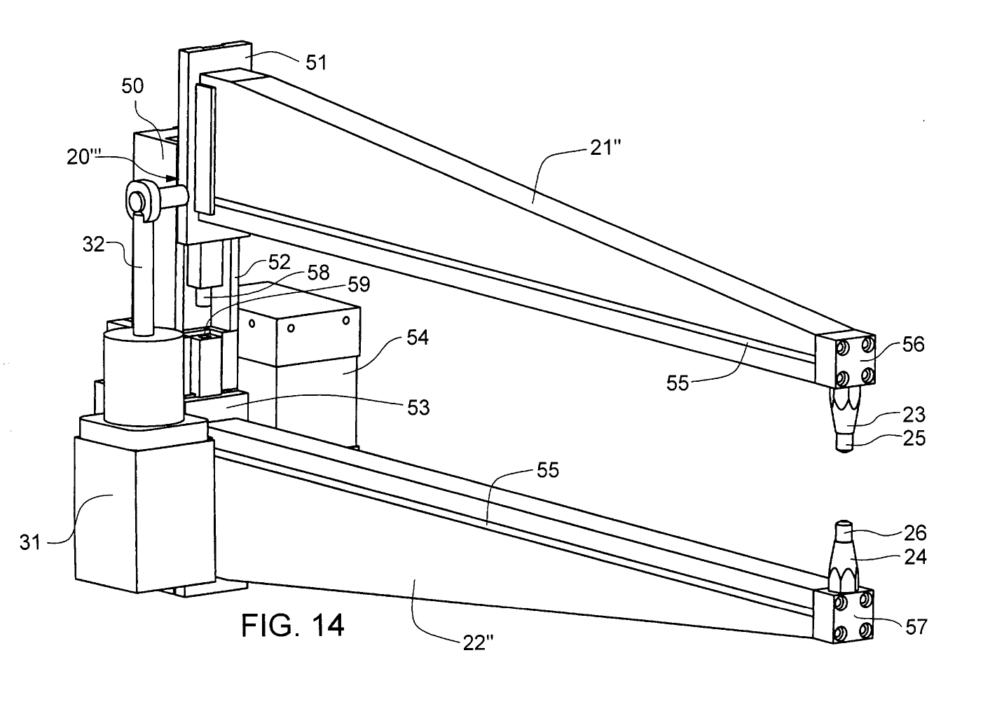

FIG. 11 shows an exemplary embodiment of a guide rail 27 to which a guide carriage 28 is linearly displaceably guided by balls 30. Components of this type are frequently used in mechanical engineering and are therefore purchased at little expense and used as linear guide 20 between the electrode arms and welding gun.

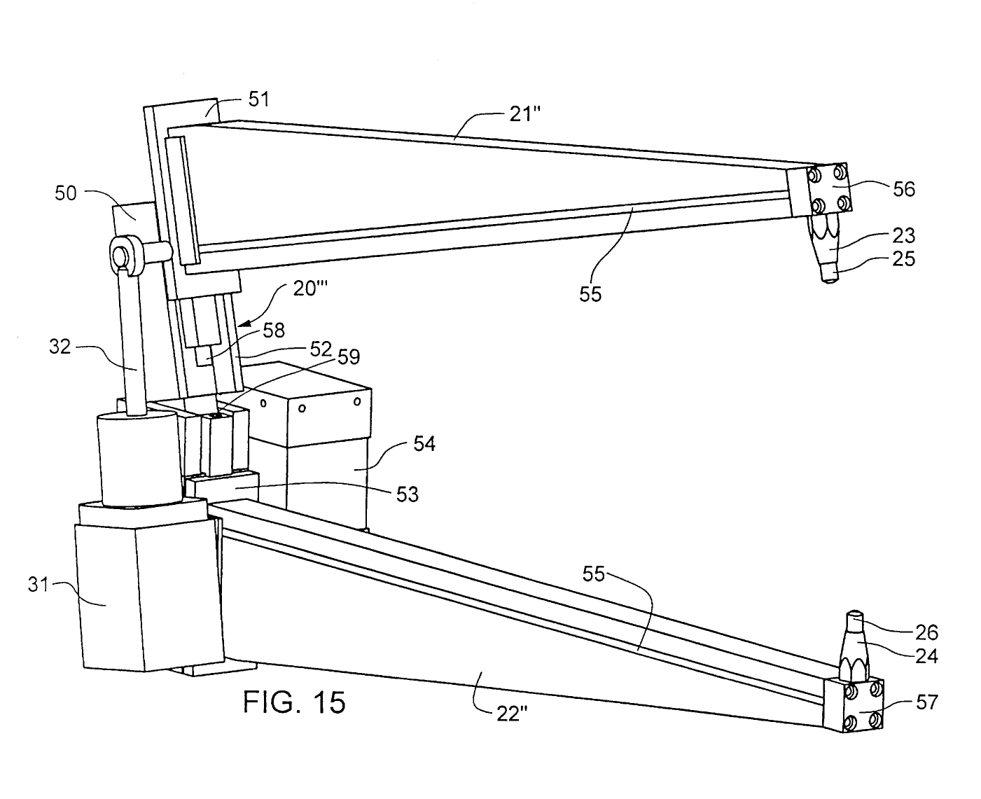

FIGS. 12 through 15 shows graphical representations of one embodiment of the welding gun according to the present invention. Linear guide 20′″ may have a design similar to the embodiment in FIG. 5 and be provided with a positive drive according to FIGS. 7a, 7b, 8a and 8b. The welding gun includes a base 50 to which a carriage 51 is displaceably attached. Guide rail 27′ is connected to the back of the carriage (see FIG. 5 and FIGS. 7a-8b). A pivot joint 38 (see FIG. 5 and FIGS. 7a-8b) is provided in base 50 so that its upper section 52 may swivel relative to its lower section 53. Electrode drive 31 is provided on one side of base 50. On the other side of base 50 there is a welding transformer 54 for supplying welding current to both electrode arms 21,,, 22,,. First electrode arm 21,, is attached to carriage 51. Second, lower electrode arm 22,, is attached to lower section 53 of base 50.

Both electrode arms 21,, and 22,, are made of an aluminum section or profile. The aluminum profile has lateral grooves 44 into which tubes are inserted for conducting coolant. Electrode holders 23, 24 are attached to electrode arms 21,,, 22,, by fastening elements 56, 57. Fastening elements 56, 57 seal the tubes containing the coolant and supply the coolant to electrode holders 23, 24 and, if necessary, welding electrodes 25, 26.

It can be seen that the welding gun first opens from the closed position shown in FIG. 12 by the linear movement of upper electrode arm 21,,. As shown in FIG. 14, a peg 58 on carriage 51 locks the pivot joint of the welding gun in its closed position. In the partially open welding gun positions shown in FIGS. 12 and 13, peg 58 engages with a peg hole 59. When carriage 51—as shown in FIG. 14—is pushed against the end stop of linear guide 20′″, peg 58 is drawn out of hole 59 and, as electrode drive 31 continues to open, upper section 52 of linear guide 20′″ is able to swivel against lower section 53 into the position shown in FIG. 15. As mentioned above, the positive drive shown in FIGS. 7a, 7b, 8a and 8b is preferably also integrated into base 50.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A welding gun comprising:
two projecting electrode arms that are interconnected and able to move relative to each other and whose free ends each hold one welding electrode;
an electrode drive that moves the electrode arms from an open position to a closed position in which the welding electrodes are located close together, characterized by a linear guide to which the electrode arms are attached in a manner such that they are displaceable transversely to each other.

2. The welding gun as recited in claim 1, wherein the linear guide is resistant to bending.

3. The welding gun as recited in claim 1, wherein the linear guide further comprises a roller bearing.

4. The welding gun as recited in claim 1, wherein the electrode drive generates a tensile force acting between the two electrode arms to move the electrode arms into the closed position.

5. The welding gun as recited in claim 1, further comprising a pivot joint that provides pivoting connection of the electrode arms.

6. The welding gun as recited in claim 5, wherein the pivot joint is provided between the two electrode arms and is connected to the linear guide.

7. The welding gun as recited in claim 5, wherein the electrode drive engages with the electrode arms between the pivot joint and the free ends of the electrode arms and is situated near the pivot joint.

8. The welding gun as recited in claim 5, wherein the electrode arms are positively driven with respect to each other so that, starting from the closed position and relative to each other, the electrode arms execute a linear opening movement in a first segment of an opening stroke of the electrode drive and execute a swivel movement around the pivot joint in a second segment of the opening stroke of the electrode drive.

9. The welding gun as recited in claim 8, wherein the linear opening movement takes place over a distance of at least 5 mm.

10. The welding gun as recited in claim 1, wherein the electrode arms are connected to the linear guide in a manner such that they are displaceable in the direction of their longitudinal axes.

11. The welding gun as recited in claim 1, further comprising:
at least one locking mechanism that provides locking of the two electrode arms in any displacement position.

12. The welding gun as recited in claim 1, further comprising
a longitudinal adjusting drive that provides longitudinal displacement of the electrode arms.

13. The welding gun as recited in claim 1, wherein the distance between at least one of the welding electrodes and the electrode arm to which it is attached is adjustable.

14. The welding gun as recited in claim 1, wherein at least one of the welding electrodes is attached to an electrode holder held in place on the free end of one of the electrode arms.

15. The welding gun as recited in claim 14, wherein the electrode holder is held on the electrode arm in a manner that allows longitudinal displacement.

16. The welding gun as recited in claim 14, further comprising:
at least one fastening element that provides electrode holder attachment in any position on the electrode arm.

17. The welding gun as recited in claim 14, further comprising:
an electrode holder drive that provides longitudinal movement of the electrode holder.

18. The welding gun as recited in claim 1, further comprising:
an equalizer drive that shifts the closed position.

19. The welding gun as recited in claim 18, further comprising:
a mounting plate connected to the linear guide in a linearly displaceable manner, the equalizer drive providing a linear displacement of the linear guide in relation to the mounting plate.

20. The welding gun as recited in claim 1, further comprising:
a pivot bearing connected to a manually movable holding shackle.

21. The welding gun as recited in claim 1, wherein the electrode arms are made of extruded profiles.

22. The welding gun as recited in claim 21, wherein the extruded profiles are made of a light alloy.

23. The welding gun as recited in claim 1, wherein the electrode arms have grooves in which tubes are provided for conducting coolant.

24. The welding gun as recited in claim 21, wherein the electrode arms have grooves in which tubes are provided for conducting coolant.

25. The welding gun as recited in claim 2, wherein the linear guide further includes a roller bearing.

26. The welding gun as recited in claim 6, wherein the electrode drive engages with the electrode arms between the pivot joint and the free ends of the electrode arms and is situated near the pivot joint.

27. The welding gun as recited in claim 4, further comprising:
a pivot joint that provides pivoting connection of the electrode arms.

28. The welding gun as recited in claim 27, wherein the electrode drive engages with the electrode arms between the pivot joint and the free ends of the electrode arms and is situated near the pivot joint.

29. The welding gun as recited in claim 4, wherein the electrode arms are connected to the linear guide in a manner such that they are displaceable in the direction of their longitudinal axes.

30. The welding gun as recited in claim 4, further comprising:
an equalizer drive that shifts the closed position.

31. The welding gun as recited in claim 4, wherein the electrode arms further include extruded profiles.

32. The welding gun as recited in claim 10, further comprising:
at least one locking mechanism that provides locking of the two electrode arms in any displacement position.

33. The welding gun as recited in claim 10, further comprising:
a longitudinal adjusting drive that provides longitudinal displacement of the electrode arms.

34. The welding gun as recited in claim 10, wherein the distance between at least one of the welding electrodes and the electrode arm to which it is attached is adjustable.

35. The welding gun as recited in claim 10, wherein at least one of the welding electrodes is attached to an electrode holder held in place on the free end of one of the electrode arms.

36. The welding gun as recited in claim 10, further comprising:
an equalizer drive that shifts the closed position.

37. The welding gun as recited in claim 10, wherein the electrode arms further include extruded profiles.

38. The welding gun as recited in claim 11, wherein at least one of the welding electrodes is attached to an electrode holder held in place on the free end of one of the electrode arms.

39. The welding gun as recited in claim 38, wherein the electrode holder is held on the electrode arm in a manner that allows longitudinal displacement.

40. A welding gun comprising:
two projecting electrode arms that are interconnected and able to move relative to each other and whose free ends each hold one welding electrode; and
displacement means coupled to the electrode arms for transversely displacing the electrode arms from one another from an open position to a closed position wherein the welding electrodes are located close together.

41. The welding gun as recited in claim 40, wherein the drive means further includes an electrode drive having a linear guide to which the electrode arms are attached.

42. An electrode drive for a welding gun, comprising:
a linear guide that provides interconnection in a manner allowing transverse relative displacement between two projecting electrode arms whose free ends each hold one welding electrode; and
a drive that provides the transverse relative displacement of the electrode arms from an open position to a closed position wherein the welding electrodes are located close together.
